(19) United States
(12) Patent Application Publication
(10) Pub. No.: US 2003/0095765 A1
(43) Pub. Date: May 22, 2003

(54) Multi-component, fused optical fiber image conduit and method of fabrication

(76) Inventor: James Triba, Stafford Springs, CT (US)

Correspondence Address: LOUIS J FRANCO, LAW OFFICE OF LOUIS J. FRANCO - LUNENBURG, 250 ARBOR STREET, LUNENBURG, MA, 01462, US

(21) Appl. No.: 10/092,149

(22) Filed: Mar. 6, 2002

Related U.S. Application Data
(60) Provisional application No. 60/331,897, filed on Nov. 20, 2001.

(51) Int. Cl. G02B 6/08; C03B 37/15

(52) U.S. Cl. 385/120; 65/410

(57) ABSTRACT

A fused optical fiber component having a predetermined profile as viewed into a plane including the longitudinal axis of the optical fiber component is fabricated according to a method including the steps of (i) fabricating a billet including a plurality of fused optical fibers extending along a longitudinal axis of the billet; (ii) positioning a billet-surrounding member over at least a portion of the outer surface of the billet; (iii) heating the billet and billet-surrounding member to a temperature sufficient to fused the billet to the billet-surrounding member and (iv) grinding the billet-surrounding member to the desired profile.

### PROVISIONAL PRIORITY CLAIM

Priority based on Provisional Application Serial No. 60/331,897, filed Nov. 20, 2001, and entitled “Fused Optical Fiber Image Conduit and Method of Fabricating the Same” is claimed.

### BACKGROUND

The transmission of images and, more generally, electromagnetic waves, through bundles comprised of adjacently fused optical fibers is an established art. Image conduits such as inverters, tapers and “straight-throughs,” for example, are well known to practitioners of the fiber optic arts. Fused optical fiber image conduits find broad application as components in such devices as night visions goggles, rifle scopes, x-ray detectors and medical imaging apparatus, by way of non-limiting example.

The basic fabrication techniques of each of the examples listed above have process steps in common. For instance, the most basic of fused optical fiber image conduits is a one-to-one, linear conduit having an input (e.g., image receiving) end and an output (e.g., image emitting) end. Light reflected from an object adjacent the input end, for instance, enters the input end as an image. The image is conducted through the conduit and exits the output end from which a detector device or human eye senses it for example. In a simple one-to-one conduit, the image exits the output end without intentional alteration. For instance, the image is not magnified, reduced or angularly displaced about the longitudinal axis of the conduit.

Referring to FIGS. A and B, as is known in the art, a basic one-to-one image conduit is an intermediate product in the fabrication of an inverter and or taper, for example. To fabricate an inverter, for instance, a one-to-one conduit is heated to an appropriate softening temperature. One end of the conduit in then angularly displaced (i.e., twisted) about the longitudinal axis of the conduit with respect to the opposite end. In the case of an inverter, the one end is twisted 180 degrees with respect to the other end. When properly controlled and executed, this process produces an inverter in which the original configuration of the face at each of the input and output ends is maintained, but in which one end is inverted with respect to the other. Accordingly, an image entering the image-receiving end is rotated as it is conducted through the constituent fibers within the fused bundle and exits the image-emitting end inverted.

Another common optical component is a fused fiber optic taper. Referring to FIGS. C1 through C3, optical fiber tapers (e.g., magnifiers and reducers) are fabricated generally as follows. A region between the first and second ends of a fused optical fiber bundle is heated to an appropriate softening temperature (or perhaps a gradient of temperatures). The heated material is stretched to increase its length and reduce its diameter. When this operation is performed on a fused bundle that is initially cylindrical, for example, the circular cross section is maintained, but the radius decreases along the length of the bundle from one end toward some minimum radius near the center. At some location between the two ends of the bundle (frequently the center), the bundle is cut to create a pair of tapers. Each taper is a magnifier or a reducer, depending on which end is used to receive a signal/image.

Regardless of the fused optical component in question (e.g., 1 to 1 image conduit, a.k.a. “a straight-through;” 1 to 1 image inverter; reducer; magnifier and/or inverting reducer/magnifier), it is sometimes necessary to mount the component in a housing or otherwise combine it with other components to form a device. A simple example is a cylindrical image conduit requiring a flanged region along its length, as shown in FIG. D2. Consider a set of device specifications requiring an image conduit having an “optically active” region of radius r and a flange of radius R. According to one current method of construction, the fabrication of a component meeting the illustrative specifications would include the preliminary fabrication of a cylindrical “billet” having a minimum radius of R, as shown in FIG. D1. The optical component to be fabricated is shown in FIG. D2 and includes a (i) flange of length L_{F}; (ii) a first region of radius r₁ extending the distance d₁ between the first face of the component and the flange and (iii) a second region of radius r₂ extending between the second face of the component and the flange. The cylindrical billet is then ground—as, for example, by CNC machining—to eliminate the unwanted material and create the first and second regions of radii r₁ and r₂. The total volume of material ground away in the process can be expressed as:

Volume of Waste=πR²L_{OC}−[πr₁²d₁+πr²_{d}₂+πR²L_{F}]

where L_{OC} is the overall length of the optical component.

It will be appreciated that the total waste as a percentage of the volume of the initial billet increases as the difference between R and r1 and/or r2 increases and as the length(s) of the region(s)—in this case, d1 and d2—increases.

There are several difficulties presented by the method of manufacture presented in the preceding paragraphs. As is known in the art of optical fiber component fabrication, a substantial amount of waste is inherent in the process of heating, drawing and fusing optical fibers, even when all goes according to plan. Moreover, the waste produced is frequently hazardous and requires proper handling and disposition. For example, where the optical fibers are made of glass—which is frequently the case—the glass ground away in forming components is often itself a hazardous material as defined by applicable environmental regulations. In addition to environmental impact, waste disposal increases production costs for an optical fiber component manufacturer.

Attempts have been made to mitigate some of the difficulties associated with the fabrication of fused optical fiber components having variable cross-sectional areas and, in particular, ones including flanges for mounting within a device. One previous alternative involves the assembly of two or more sub-components to increase the cross-sectional area in predetermined regions. FIGS. E1 and E2 depict an illustrative method in which a metal ring or sleeve serves as a flange. As shown in FIGS. E1 and E2, a previous method of fabricating an optical fiber component having a flange of radius R includes the preliminary step of fabricating a fused image-conducting billet of radius r_{b}, where r_{b} is less than R. A shoulder region SR is then formed by grinding, for example, and joins a region of radius r_{b} with a region having a radius rₓ, where rₓ is less than r_{b}. A frit ring, for example, is positioned in resting engagement with the shoulder region SR. The metal ring or sleeve that serves as the flange is urged into contacting engagement with the frit ring. The assembly is heated so that at least the frit ring softens to fuse with the billet and adhere to the metal ring/sleeve.

Among the disadvantages of using metal to form a flange are the following: (i) metal and glass have different, and frequently incompatible, physical properties including, for instance, thermal conductivity, electrical conductivity and thermal expansion coefficients and (ii) metal flanges have proven difficult to align as desired over the billet. Moreover, there are some industrial applications for which the optical component must be substantially homogeneous and for which the combination of materials as disparate as metal and glass, for example, is unacceptable, even if the other enumerated disadvantages of metal flanges could be circumvented.

Accordingly, there is a need for a method of fabricating a fused optical fiber image conduit that alleviates the disadvantages of the single-piece fabrication described above and that results in an optical component that exhibits characteristics more consistent with single-piece, homogeneous (e.g., all glass versus metal on glass) fabrication than with the multi-piece fabrication heretofore attempted.

### SUMMARY

The present invention is directed to a method of fabricating a substantially homogenous fused optical fiber image conduit of irregular (e.g., flanged) profile and, in various embodiments, to components made in accordance with the method.

In one aspect, a method of fabricating a rigid optical fiber image conduit includes fabricating a “preform” billet having a signal-receiving end and a signal-emitting end. In many instances, the signal received and emitted is an image comprised of light in the visible spectrum. The billet includes a plurality of fused optical fibers extending generally along a longitudinal axis between the signal receiving and signal emitting ends. Each optical fiber includes a core and a cladding, the cladding being formed from a first material. In various aspects, the core and the cladding will comprise glasses of differing indices of refraction. The formation of such billets is generally known among fabricators of optical fiber components.

According to various implementations, the billet is formed to include a shoulder of predetermined contour in a region between the signal-receiving and signal-emitting ends. For example, in the case of a billet having a substantially cylindrical exterior surface, forming the shoulder in various aspects involves grinding the exterior surface of the billet to reduce its diameter for some distance along its length. A shoulder connects a region of one diameter with a region of a different diameter, for example.

Another illustrative example involves a taper that, once formed, already includes a profile of varying diameter. Referring to FIGS. C2 and C3, a taper of circular cross-section has a profile including a region along which its diameter gradually increases. This “tapered” region, for purposes of various implementations, includes an infinite number of infinitesimally small “shoulders.” That is, within the tapered region, for any first plane oriented perpendicularly to the longitudinal axis of the taper so as to define a region of circular cross section, there is an immediately adjacent second plane defining a circular region of larger diameter and an immediately adjacent third plane, on the opposite side of the first plane from the second plane, defining a circular region of smaller diameter. The difference in diameters of the circular regions in any two different planes represents a diameter gradient along the taper. A “shoulder” can be defined in terms of one or more gradients, depending on variations in slope, etc. along the shoulder. Accordingly, because there is an infinite number of planes along the tapered region, an infinite number of shoulders exist. Even so, the exterior surface of a taper may still be ground to form a shoulder including a surface parallel to the longitudinal axis of the taper and a surface perpendicular to the longitudinal axis of the taper in order to prepare it for subsequent steps in the process.

In various aspects, the method further includes providing a first billet-surrounding member having an opening therethrough. The first billet-surrounding member is adapted for sliding axially over one end of the billet toward the shoulder and for arresting engagement by the shoulder. At least the opening in the first billet-surrounding member is of similar geometry to a region of the billet adjacent the shoulder. A simple example is a billet-surrounding member having a circular opening for receiving a billet of circular cross-section (e.g., a ring). However, as is known in the art, fused billets of numerous shapes are made. Common illustrative examples include billets of square, rectangular, hexagonal and octagonal cross-section. Accordingly, the opening in the billet-surrounding member should be similar in shape to the billet over which it is to be mounted. Although a “ring” typically conjures a circular shape, the term “ring” may be used throughout the summary, description and claims to reference billet-surrounding members of various shapes, including, for instance, circular, square, rectangular, hexagonal, etc. That is, the use of the term “ring” should not be construed as a limitation to an element of circular shape. Moreover, “billet-surrounding member” alternatively refers to elements adapted to completely circumscribe a billet (e.g., an O-shaped element) and elements adapted to only partially encompass a billet (e.g. a C shaped member).

The first billet-surrounding member is comprised of a second material that, in various aspects has a softening temperature and thermal expansion coefficients compatible with those of the first material from which the fiber claddings are formed. For example, as will be appreciated, a particular billet-surrounding member having a softening temperature substantially higher than that of a particular billet would typically be incompatible with that billet. Conversely, a particular billet-surrounding member with a softening temperature comparable to or lower than a particular billet would typically be more compatible with that billet for purposes of the method of fabrication. In one or more aspects, the first and second materials may be the same. In another illustrative alternative, the claddings of the optical fibers are made of glass and the first billet-surrounding member is made from frit.

Frit is commercially available in various forms. One form of frit is powderized glass. Frit powder can be softened and shaped within a mold by the introduction of sufficient heat and pressure. In various aspects of the current fabrication method, it is advantageous to form a first billet-surrounding member from devitrifying frit. The advantageousness of devitrifying frit for use in connection with the current method will become apparent. Presently, it is sufficient to observe that devitrifying frit exhibits disparate physical properties at different temperatures. More specifically, a devitrifying frit powder can be introduced into a mold and heated to a predetermined first softening temperature. The first softening temperature is such that the frit powder softens to form a structure of “stuck-together” granules or particles. At this stage, the structure is an amorphous (non-crystalline structure). It is advantageous to fabricate or otherwise procure a first billet-surrounding member made in this way.

A first billet-surrounding member formed of devitrifying frit is—at an appropriate time in the fabrication of the optical component—heated to a second, higher “firing” temperature at which it “devitrifies.” That is, the glass particles within the structure of the ring pass from amorphous to crystalline. Once crystallized, the frit has a higher softening temperature than it previously had. In other words, in the context of implementation in the current method, devitrifying frit has a “one-time” softening temperature that is attained to form an amorphous glass and a higher, second temperature, at which the amorphous glass crystallizes.

Various aspects include the step of providing a second billet-surrounding member having a billet-receiving opening and being adapted for sliding axially over the billet and contacting engagement with the first billet-surrounding member. In alternative implementations, like the first billet-surrounding member, at least the opening in the second billet-surrounding member is of similar geometry to a region of the billet adjacent the shoulder and/or at least a portion of the outer surface of the first billet-surrounding member. In some versions, the second billet-surrounding member includes an interior surface having a predetermined contour adapted to fit over and contactably engage at least a portion of the length of the first billet-surrounding member. Alternative second billet-surrounding members are formed from a third material that is (i) different from the first and second materials; (ii) the same as one of the first and second materials and (iii) the same as both the first and second materials.

The first billet-surrounding member and the second billet-surrounding member are preliminarily urged against the shoulder such that a portion of the shoulder exerts a force opposing further axial advancement of the first and second billet-surrounding members. The combined sub-components (i.e., billet and first and second billet-surrounding members) are then heated to a temperature sufficiently high to soften at least the first billet-surrounding member so that the first billet-surrounding member fuses with the billet and the second billet-surrounding member. In alternative implementations, the temperature to which the sub-components are heated is sufficient to soften at least one of the second billet-surrounding member and at least a portion of the billet, in addition to the first billet-surrounding member.

In illustrative, alternative versions, the second billet-surrounding member is made from (i) molded waste glass; (ii) cut scrap billets with center regions removed therefrom; (iii) cut glass tubing. For instance, discarded fused bundles can be cut, drilled and ground to form billet-surrounding members for billets of smaller outer diameter than the scrap bundle. This represents one way in which scrap material can be reclaimed and incorporated into a useful optical component. As a flange, for example, fused image conduits with compromised optical properties that would otherwise be relegated to the waste barrel are re-used. In another alternative implementation, a glass tube of inner radius rᵢ and outer radius rₒ is sliced to created billet-surrounding members having an inner radius that is greater than or equal to rᵢ and an outer radius that is less than or equal to rₒ.

The fusing of the first billet-surrounding member to the billet and the second billet-surrounding member creates a single fused component. When the first, second and third materials are all glass, for instance, the fused single components can be ground and polished in much the same fashion as a single fused bundle is ground and polished. Among the differences, however, are that considerably less wasted optical fiber, labor and time results while reducing environmental pollutants. The more similar the physical (and chemical) characteristics of the first, second and third materials, the more “homogeneous” the finished optical component will be. Recognizing that optical components constructed in accordance with the invention may not be truly “homogeneous” in the strict, technical sense that, for instance, a chemist, engineer or materials scientist might use the term, a liberal use of the term “homogenous” will allow >that glass fused to glass will typically result in a more homogeneous or “congruous” construction than glass adhered to metal, for instance. In this regard, “homogeneous” is used herein with maximum liberality to indicate a degree of “congruity.” The more congruous the assembled component, the more the component will behave like an image conduit ground and polished from a single fused optical fiber bundle. In alternative versions and applications, relevant physical and chemical properties may include (i) thermal expansion coefficients; (ii) solubility in various solutions; (iii) density; (iv) rigidity and (v) brittleness, by way of non-limiting example.

In alternative versions, the shoulder and/or the first billet-surrounding member includes a contoured surface adapted to facilitate the centering and alignment of the first billet-surrounding member about the billet. Similarly, in alternative versions, at least one of the first billet-surrounding member and the second billet-surrounding member includes a contoured surface adapted to facilitate the proper alignment of the second billet-surrounding member about the billet. These contoured surfaces may be beveled and or curved, for example.

In another aspect, a billet is placed into an elongated billet-surrounding member that at least partially surrounds the billet. In one example, the elongated billet-surrounding member is an “envelope tube.” The envelope tube has an inner surface with a contour compatible with the outer contour of the billet such that at least a portion of the inner surface can be fused with the outer surface of the billet. For instance, in one version, the billet is of circular cross-section and the envelope tube has an inner surface that is of circular cross-section defining a billet-receiving channel with an inside diameter close to the diameter of the billet. Once the billet is positioned within the envelope tube, the tube and billet are fused together. Once the envelope tube is fused to the billet, the envelope tube is ground to a predetermined profile as viewed, for instance perpendicularly to the longitudinal axis of the billet. As with the billet-surrounding members previously discussed, elongated billet-surrounding members may be of various alternative configurations including, for example, the illustrative configurations shown in FIGS. 4A through 4F.

### BRIEF DESCRIPTION OF THE DRAWINGS

FIG. A depicts a linear fused image conduit of the prior art, which is also referred to as a “straight through;”

FIG. B shows a fused optical fiber image-inverting conduit of the prior art;

FIG. C1 shows a fused optical fiber bundle that has been heated and stretched in order to form tapers, as is known in the art;

FIG. C2 shows a fused optical fiber image magnifier (a.k.a., an enlarger);

FIG. C3 shows a fused optical fiber image reducer;

FIGS. D1 and D2 illustrate how a fused image conduit of regular profile is ground to form a single-piece image conduit having an irregular (i.e., in this case flanged) profile in accordance with a prior method;

FIGS. E1 and E2 depict the assembly of a multi-sub-component optical component in accordance with a prior method;

FIGS. 1 through 3 depict an illustrative implementation of a method of fabricating a fused optical fiber image-conducting component;

FIGS. 4A through 4F depict various, non-limiting examples of billets having various cross-sections bounded, in whole or in part, by billet surrounding members; and

FIGS. 5A, 5B and 5C depict, respectively, the insertion of a billet into an illustrative elongated billet-surrounding member, a cross section of the envelope tube fused about the billet and the envelope tube ground to a predetermined profile.

### DETAILED DESCRIPTION

The following description of a method of fabricating a fused optical fiber image-conducting component, and of an optical fiber component fabricated in accordance therewith, is demonstrative in nature and is not intended to limit the invention or its application of uses. The various implementations, aspects, versions and embodiments described in the summary and detailed description are in the nature of non-limiting examples falling within the scope of the appended claims and do not serve to define the maximum scope of the claims.

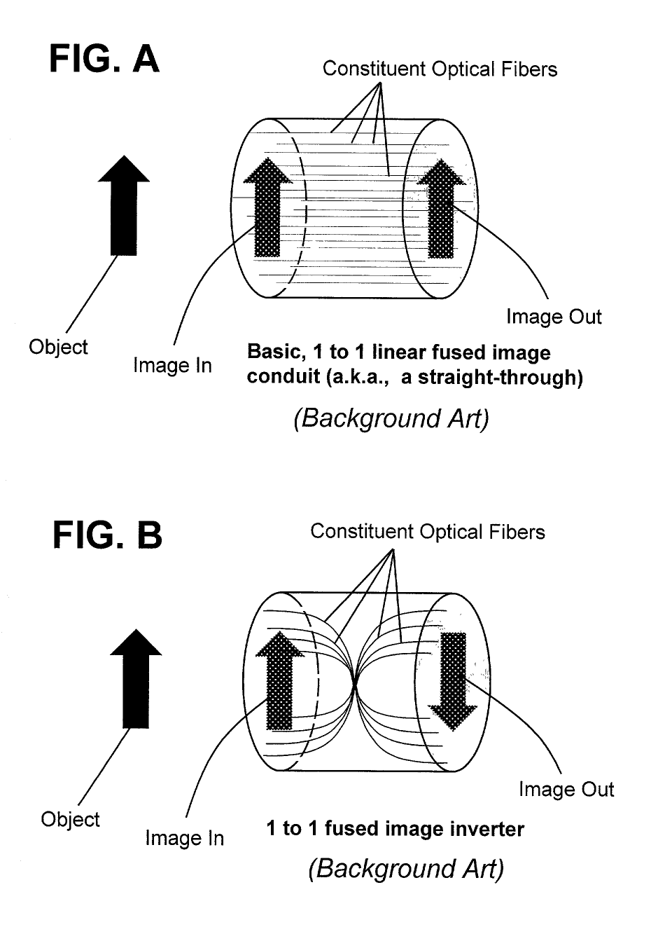

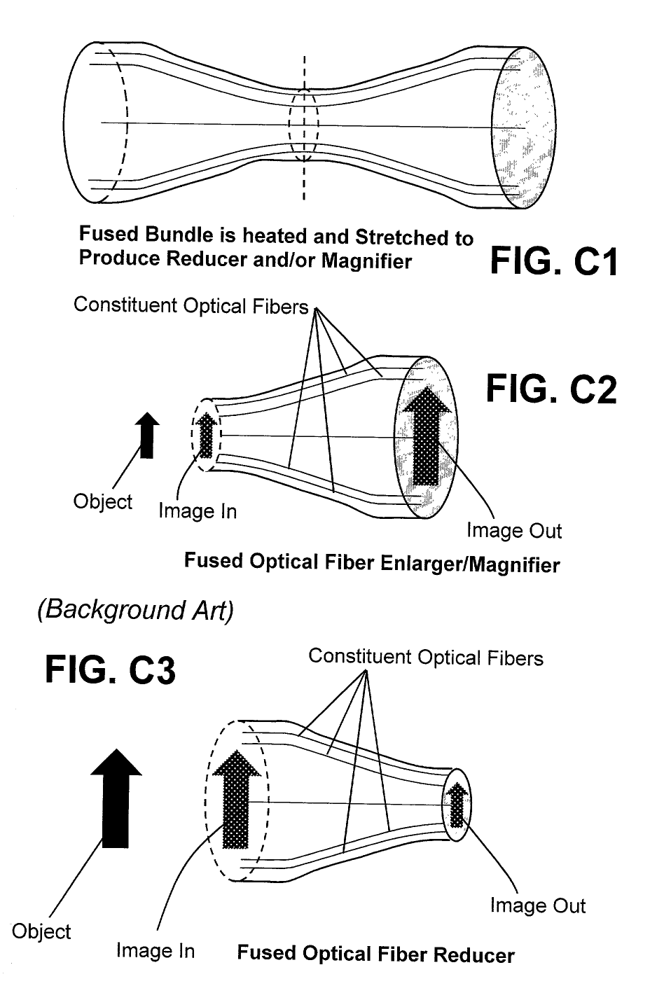

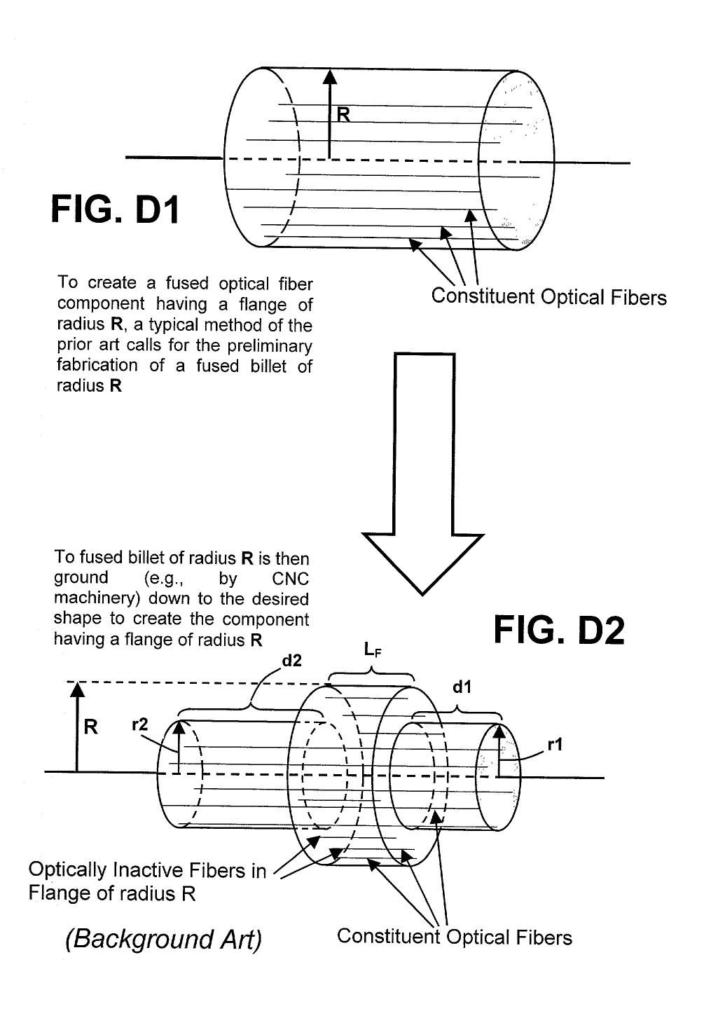

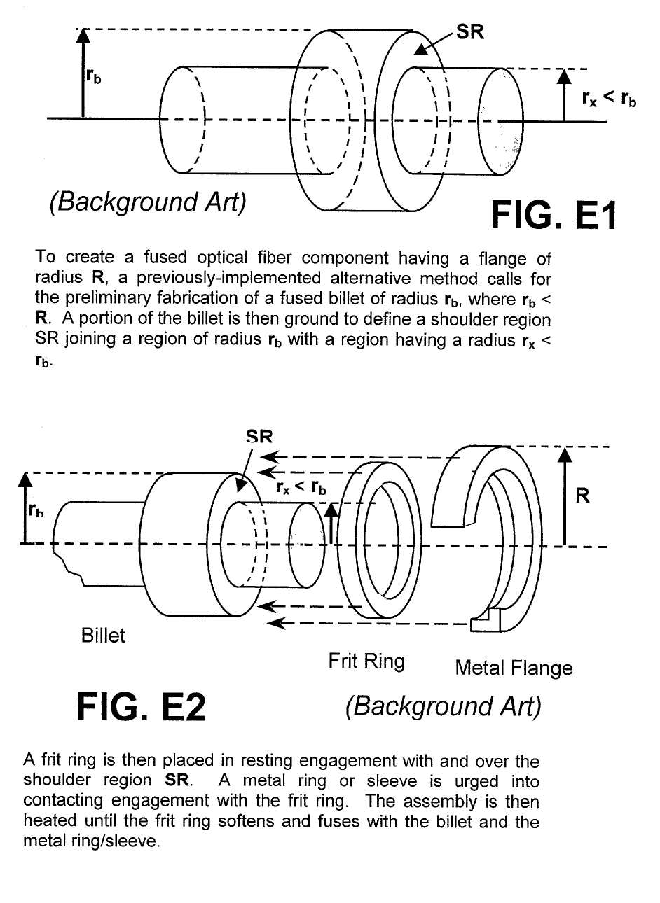

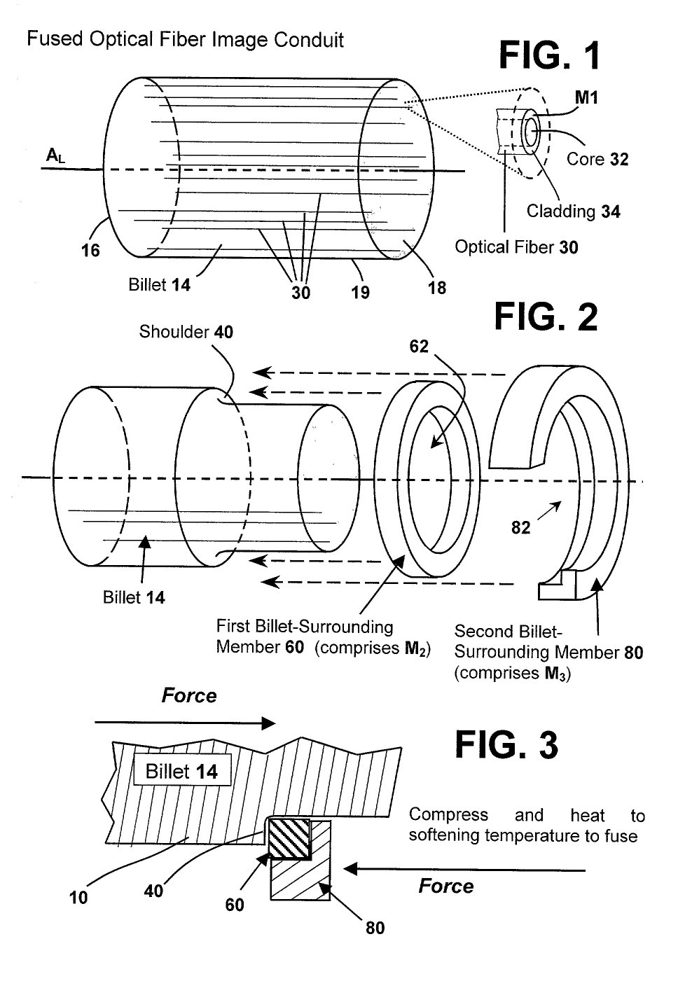

Referring to FIG. 1, in accordance with various implementations, a method of fabricating a rigid optical fiber image-conducting component includes providing a “preform” billet 14 having a signal-receiving end 16, a signal-emitting end 18 and an outer surface 19 extending between the signal-receiving and signal-emitting ends 16 and 18. The billet 14 includes a plurality of fused optical fibers 30 extending generally along a longitudinal axis AL between the signal receiving and signal emitting ends 16 and 18. Each optical fiber 30 includes a core 32 and a cladding 34, the cladding 34 being formed from a first material M1. In various aspects, the core 32 and the cladding 34 comprise glasses of differing indices of refraction as is known in the art. The formation of such billets 14 is generally known among fabricators of optical fiber components.

The billet 14 is formed to include a shoulder 40 of predetermined contour in a region between the signal-receiving and signal-emitting ends 16 and 18. In various implementations, the shoulder 40 is formed by grinding the exterior surface of the billet 14 to reduce the diameter (or radius) for some distance along the length of the billet 14. A shoulder 40 connects a region of one diameter with a region of a different diameter, for example. Although “diameter” is frequently thought of narrowly as the longest chord that can be fit within the curve defining a circle, the more general definition of that term is applicable to this description and the appended claims. For instance, chords within squares, rectangles, hexagons, and even, irregular shapes are also diameters. A radius is a line segment extending from the geometric center of a shape to the boundary of the shape. Nothing in the preceding explanation should be construed to attribute to the terms “diameter” and “radius” a meaning more narrow than common usage and technical mathematical usage would attribute to them.

In various implementations, a method further includes providing a first billet-surrounding member 60 adapted for completely surrounding the billet 14 and having an opening 62 therethrough. The first billet-surrounding member 60 is adapted for sliding axially over one end of the billet toward the shoulder 40 and for arresting engagement with the shoulder 40. At least the opening 62 in the first billet-surrounding member 60 is of similar geometry to a region of the billet adjacent the shoulder 40. A simple example is a billet-surrounding member 60 having a circular opening 62 for receiving a billet 14 of circular cross-section (e.g., a ring), as shown in FIG. 2. However, fused billets 14 of numerous shapes are known and used in the industry. Common illustrative examples include billets of square, rectangular, hexagonal and octagonal cross-section. Accordingly, the opening in the billet-surrounding member 60 should be similar in shape to the billet 14 over which it is to be mounted.

Alternative versions include use of a first billet-surrounding member 60 that is not adapted to completely surround the billet 14. Such billet-surrounding members 60 may or may not need to be axially guided to the shoulder 40, depending on the shape of the billet 14 and the first billet-surrounding member 60. Each billet-surrounding member 60 that is not adapted for complete circumscription of the billet 14 is still placed in resting engagement with the shoulder 40 and covers a portion of the exterior surface of the billet 14.

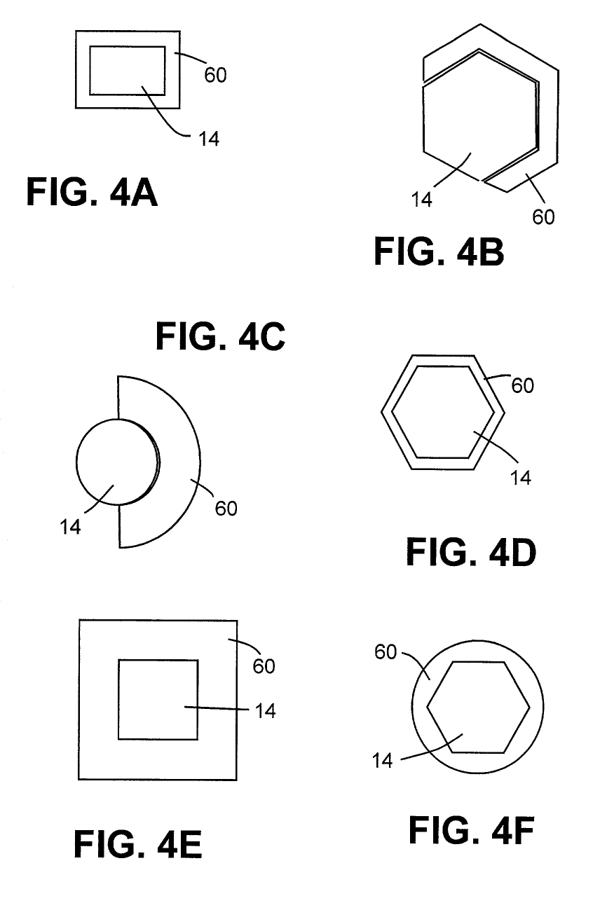

A non-limiting illustrative set of variously shaped billets 14 and first billet-surrounding members 60 is shown in FIGS. 4A through 4E. FIG. 4A depicts a billet 14 of rectangular cross section completely surrounded by a rectangular billet-surrounding member 60. FIG. 4B shows a billet 14 of hexagonal cross section partially surrounded (i.e., along four sides) by a billet-surrounding member 60. FIG. 4C shows a billet 14 of circular cross section one half of which is surrounded by a billet-surrounding member 60 of semi-circular cross section. FIG. 4D shows a billet 14 of hexagonal cross section completely surrounded by a hexagonal billet-surrounding member 60. FIG. 4E shows a billet 14 of square cross section completely surrounded by a billet-surrounding member 60. FIG. 4F shows a billet 14 of hexagonal cross section completely surrounded by a circular billet-surrounding member 60.

As previously disclosed, the first billet-surrounding member 60 comprises a second material M₂. In various aspects, the first billet-surrounding member 60 has a softening temperature and thermal expansion coefficients compatible with those of the first material M₁ from which the fiber claddings 34 are formed. It is advantageous for the first billet-surrounding member 60 to have a lower softening temperature than the billet 14. In another illustrative alternative, the claddings 34 of the optical fibers 30 are made of glass and the first billet-surrounding member 60 is made from a devitrifying or non-devitrifying frit. Various aspects further include the step of providing a second billet-surrounding member 80. As with the first billet-surrounding member 60, the second billet-surrounding member 80 may be adapted for complete or partial circumscription of the billet 14. In an aspect implementing a second billet-surrounding member 80 adapted to completely surround the billet 14, the second billet billet-surrounding member 80 includes a billet-receiving opening 82 and is adapted for sliding axially over the billet 14 to be placed in contacting engagement with the first billet-surrounding member 60. Alternative second billet-surrounding members 80 are formed from a third material M₃ that is (i) different from the first and second materials M₁ and M₂; (ii) the same as one of the first and second materials M₁ and M₂ and (iii) the same as both the first and second materials M₁ and M₂.

As shown in FIGS. 2 and 3, the first billet-surrounding member 60 and the second billet-surrounding member 80 are urged against the shoulder 40 such that a portion of the shoulder exerts a force opposing further axial advancement of the first and second billet-surrounding members 60 and 80. The combined sub-components (i.e., billet 14 and first and second billet-surrounding members 60 and 80) are then heated to a temperature sufficiently high to soften at least the first billet-surrounding member 60 so that the first billet-surrounding member fuses with the billet 14 and the second billet-surrounding member 80.

Once the fused assembly cools, it can be machined or otherwise polished and ground to bring its profile within tolerances where required or to otherwise modify its shape and/or texture as desired.

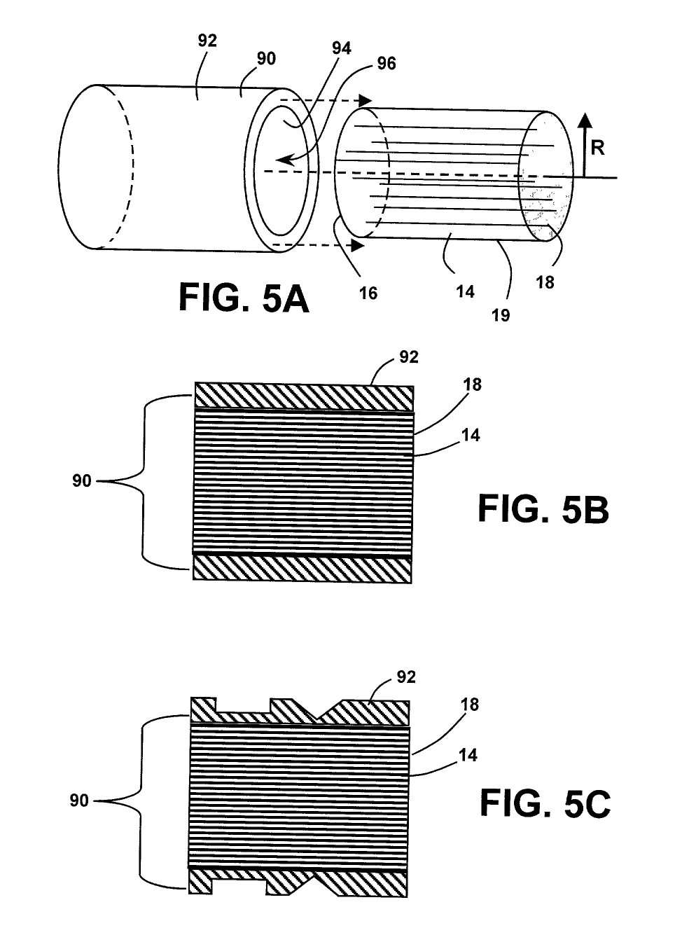

Referring to FIGS. 5A through 5C, alternative assembly involves an elongated billet-surrounding member 90. In the particular example of FIGS. 5A through 5C, the elongated billet-surrounding member 90 is an “envelope tube” having an outer surface 92 and an inner surface 94 that completely surrounds the billet 14 along at least a portion of the length of the billet 14. As depicted, the billet 14 is placed into the elongated billet-surrounding member 90 through a billet-receiving channel 96 with an inside diameter close to the diameter of the billet. Once the billet 14 is positioned within the envelope tube 90, the tube 90 and billet 14 are fused together. That is, at least a portion of the inner surface 94 of the billet-surrounding member 90 is fused to at least a portion of the outer surface 19 of the billet 14. Once the elongated billet-surrounding member 90 is fused to the billet 14, the elongated billet-surrounding member 90 is ground to a predetermined profile as viewed, for instance perpendicularly to the longitudinal axis of the billet 14. An illustrative profile is shown in FIG. 5C.

The foregoing is considered to be illustrative of the principles of the invention. Furthermore, since numerous modifications and changes will readily occur to those skilled in the art, it is not desired that the foregoing limit the invention to the exact construction and operation shown and described. Accordingly, all suitable modifications and equivalents may be resorted to that appropriately fall within the scope of the invention as expressed in the appended claims.

What is claimed is:

1. A method of fabricating a fused optical fiber component comprising:
fabricating a billet having a signal receiving end and a signal emitting end and including a plurality of fused optical fibers extending generally along a longitudinal axis between the signal receiving and signal emitting ends;
reducing the diameter of the billet along a portion of the length of the billet so as to form a shoulder having a predetermined contour;
providing a first billet-surrounding member adapted for sliding axially over one end of the billet and arresting engagement by the shoulder;
providing a second billet-surrounding member adapted for sliding axially over the billet and having a predetermined interior contour adapted to fit over and contactably engage at least a portion of the length of the first billet-surrounding member;
sliding the first billet-surrounding member over one end of the billet and bringing it into contacting engagement with the shoulder of the billet and sliding the second billet-surrounding member over the billet, the first and second billet-surrounding-members being slid over the billet one of (i) simultaneously and (ii) first member first and second member second;
urging the first and second billet-surrounding members toward the shoulder; and
heating the billet and the first and second billet-surrounding members to a softening temperature sufficient to fuse the first billet-surrounding member to the billet and the second billet-surrounding member to the first billet-surrounding member so as to form a single, fused component.

2. The method of claim 1 further comprising at least one of (i) grinding and (ii) polishing the single piece to a predetermined profile.

3. The method of claim 1 wherein the first billet-surrounding member comprises frit.

4. The method of claim 3 wherein the frit is devitrifying frit.

5. The method of claim 1 where in the billet, the first billet-surrounding member and the second billet-surrounding member are comprised of glass.

6. A method of fabricating a fused optical fiber component comprising:
fabricating a billet having a signal receiving end and a signal emitting end and including a plurality of fused optical fibers extending generally along a longitudinal axis between the signal receiving and signal emitting ends, each optical fiber including a core and a cladding, the cladding being formed from a first material;
reducing the diameter of the billet along a portion of the length of the billet so as to form a shoulder having a predetermined contour;
providing a first ring adapted for sliding axially over one end of the billet and arresting engagement by the shoulder, the first ring being formed from a second material;
providing a second ring adapted for sliding axially over the same end of the billet as the first ring and having a predetermined interior contour adapted to fit over and contactably engage at least a portion of the length of the first ring, the second ring being formed from a third material;
sliding the first ring over one end of the billet and bringing it into contacting engagement with the shoulder of the billet and sliding the second ring over the same end of the billet as the first ring, the first and second rings being slid over the end of the billet one of (i) simultaneously and (ii) first ring first and second ring second;
urging the first and second rings toward the shoulder; and
heating the billet and the first and second rings to a softening temperature sufficient to fuse the first ring to the billet and the second ring to the first ring so as to form a single piece.

7. The method of claim 6 wherein at least one the following conditions is met:
(i) the first, second and third materials are the same material;
(ii) at least two of the first, second and third materials are the same material;
(iii) at least one of the first, second and third materials is different than the other two materials and the first, second and third materials have compatible softening temperatures and thermal expansion coefficients.

8. A method of fabricating a fused optical fiber component having a predetermined profile comprising:
fabricating a billet having a signal receiving end, a signal emitting end and an outer surface extending between the signal receiving and signal emitting ends, the billet further including a plurality of fused optical fibers extending generally along a longitudinal axis between the signal receiving and signal emitting ends, each optical fiber including a core and a cladding;
providing an elongated billet-surrounding member adapted to at least partially surround the billet and having an inner surface and an outer surface;
placing at least a portion of the outer surface of the billet in contact with at least a portion of the inner surface of the elongated billet-surrounding member;
heating the elongated billet-surrounding member and the billet to a temperature sufficient to fuse the elongated billet-surrounding member to the billet; and
grinding the outer surface of the elongated billet-surrounding member to the predetermined profile.
